(19) United States
(12) Patent Application Publication
(10) Pub. No.: US 2016/0021048 A1
(43) Pub. Date: Jan. 21, 2016

(54) Dynamically Expanding and Contracting Group

(71) Applicant: Joseph Raymond Grutta, Satellite Beach, FL (US)

(72) Inventor: Joseph Raymond Grutta, Satellite Beach, FL (US)

(73) Assignee: FAR OR NEAR LLC, Satellite Beach, FL (US)

(21) Appl. No.: 14/804,388

(22) Filed: Jul. 21, 2015

Related U.S. Application Data
(60) Provisional application No. 62/026,858, filed on Jul. 21, 2014.

(51) Int. Cl. H04L 12/58; H04L 29/08; H04W 4/02

(52) U.S. Cl. CPC H04L 51/20; H04W 4/02; H04L 51/16; H04L 51/32; H04L 51/36; H04L 67/18; H04L 67/1044

(57) ABSTRACT

A group within the context of a social networking website or mobile application that expands or contracts to show content objects and entities based on a geographic location and the distance from that location.

### CROSS-REFERENCE TO RELATED APPLICATIONS

This application claims the benefit of U.S. Provisional Application No. 62/026,858, filed Jul. 21, 2014.

### BACKGROUND

The invention relates generally to social networking and, in particular to providing relevant content objects and entities within online communities that may be relevant to a user of a social networking system based on a geographic location.

There has not been an easy way for people to find other people that share their hobbies and interests. The information that might allow them to do so was scattered across many websites and not organized in a way that would make doing so easy. Several sites, such as Meetup, tried to address this by allowing users to create groups for their existing real-world groups or groups they planned on organizing. The model followed by these sites relies upon an organizer creating a group, which others can then join. But, this approach only works if someone takes the initiative to create a group and some of the sites that follow this approach charge group organizers a fee to do so. Many users of these sites will be disappointed to find that there is no group for their hobby or interest near them and, if there is, that they may have to help the organizer cover their cost by paying a fee to be an active member of the group and attend events.

### SUMMARY

The invention involves a dynamically expanding and contracting group within the context of a social networking website or mobile application. Within the dynamically expanding and contracting group, users can post content and create or subscribe to various entities, such as sub-groups and events. A user can change their current location and specify a distance from their location for which they wish to see content. The user will see posts, a list of subscribers and suggested entities, such as groups and events that they may find interesting, that are associated with the geographic area they define.

### DESCRIPTION

The invention makes anyone that subscribes to or otherwise participates in one of the dynamically expanding and contracting groups, which may be referred to hereafter as interest communities or singularly as an interest community, part of a larger community, which can be centered on a specific hobby or interest.

Each interest community is global in scope, but the content objects and entities displayed within the interest community can be restricted to show those most relevant to a user based on a geographic location.

Within an interest community, a user can post content and find content posted by other users. They can also create, discover, or subscribe to various different entities, such as sub-groups and events, as well as view a list of other subscribers associated with the specified geographic area. As a result, there is no need for a user to create a group for their interest or hobby. They can participate directly within one of these pre-created interest communities.

In one embodiment of the present invention, sub-groups and events can be created within an interest community. Within an interest community, a user can view or create posts, comment on existing posts, see a list of subscribers and create or discover events and sub-groups that are associated with the geographic area they define. The user can adjust both their location and the distance from it.

As a result, a user can find other subscribers of the interest community and information related to the interest easily, regardless of whether a group has been created near them.

In one embodiment of the present invention, a user's location is determined based on the value of a field within a database that stores the zip code of the user's current location. The user can update this field by entering a zip code. If no value is stored for the current location, then the zip code of the address associated with the user's account is used.

In another embodiment of the present invention, the user's location can alternately be determined based on the GPS coordinates of the user's mobile device, if supported, and used to update the current location field associated with the user.

And, in yet another embodiment of the present invention, the user's location can alternately be determined based on the IP address of the user's device and used to update the current location field associated with the user.

In one embodiment of the present invention, a public message is associated with a user and its location will be the current location of that user. In the absence of a value for the current location field, the zip code of the address associated with the user's account is used.

In another embodiment of the present invention, each public message has its own location field within a database, which initially stores the zip code from the current location field associated with the user making the post or, if not available, the zip code of the address associated with the user's account.

The distance for which a user wishes to see content can be selected for each interest community. If a user does not specify a distance, then a default distance will be used. A user can subscribe to an interest community, which creates an entry within a database. If a user is subscribed to an interest community, then any distance value they select will be stored to a database and used the next time they visit the interest community. This value will also be used when determining which content to display on the user's home feed, which shows content from all entities that the user is subscribed to and for which they have the necessary permissions to view. An entity can be a user, interest community, group, event or any other structure that can have content associated with it.

In one embodiment of the present invention, a user can create a sub-group, called a “group”, which other users can subscribe to. The location of the group can be set by an administrator. By default, the zip code of the address associated with the account of the user who created the group is used.

In this embodiment a user can also create an event associated with the interest community or any sub-group. The location of the event is based on the zip code of the venue where the event will be hosted, as specified by the user when they create the event.

In this embodiment, when a user visits the interest community, one or more of the following lists may be displayed:

My Events: Events associated with the interest or groups belonging to the interest for which the user has already subscribed. These are not filtered by distance. In another embodiment these are filtered by distance.

My Groups: Groups associated with the interest for which the user has already subscribed. These are not filtered by distance. In another embodiment these are filtered by distance.

Suggested Events: Events that are in the defined geographic area that the user is not subscribed to and that are associated with the interest or with a group associated with the interest. In another embodiment, events associated with groups are limited to only events from groups that the user is subscribed to.

Suggested Groups: Groups associated with the interest that the user has not subscribed to and that are in the geographic area that has been defined.

In addition, the user may also view a list of subscribers that fall within the geographic area defined and the user will see posts that fall within the geographic area defined by the distance selected by the user or provided by default. In this embodiment the zip code used for the message is based on the current location of the user that made the post or, if not available, the zip code of the address associated with the user's account. In another embodiment, a separate location is set for each message.

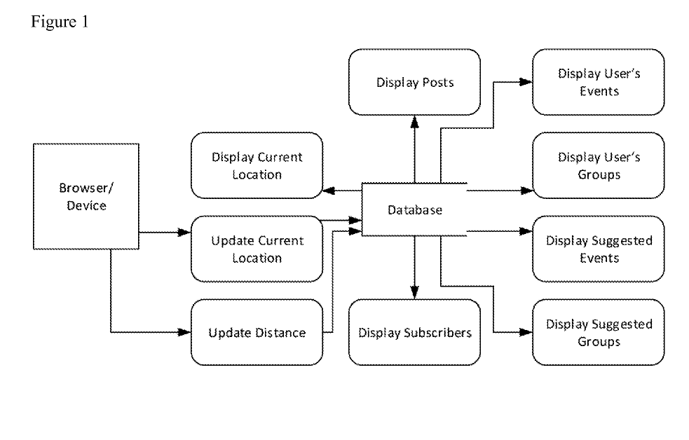

FIG. 1 shows the data flow for one embodiment of the present invention. Each line represents one or more pieces of information and the arrow indicates the direction of the data flow.

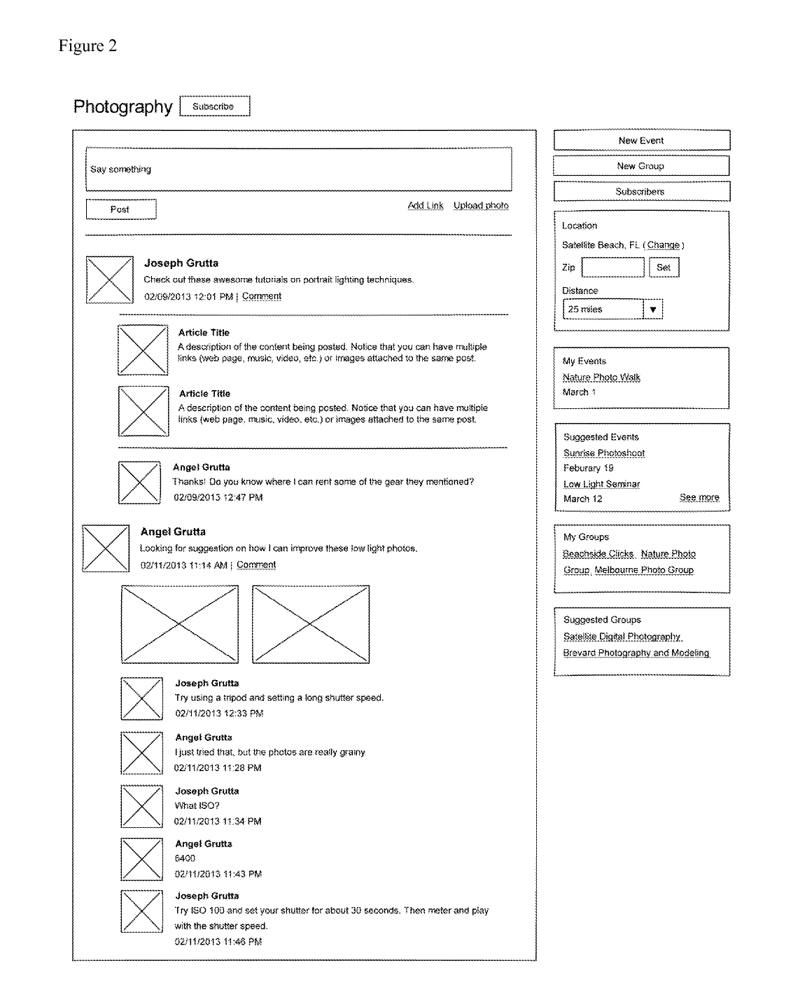

FIG. 2 illustrates the user experience for one embodiment of the present invention. When a user clicks the “Change” link next to their location, the Zip field appears. The user can then enter a zip code and click “Set” which will update the current location and display the city.

Changing the distance, will change which posts are displayed, and which events and groups are displayed under suggested events and suggested groups. It will also affect which subscribers are displayed when the user clicks on “Subscribers”.

Another alternative embodiment of the present invention could filter posts and suggested entities by geographic area, but not include a list of subscribers.

In an alternate embodiment of the present invention, content is filtered by both distance from a location and age. A user can set a range of ages and see posts from users that fall within that age range and who are also in the specified geographic area. A target age range can be set for each entity and only entities that overlap the age range set by the user or that are intended for all ages will be suggested.

In another alternative embodiment of the present invention, certain entities can have fields set by their creator or another user with the necessary privileges that restricts which users the entity is suggested to. For example, a target age range could be set for a group. The group would only appear under suggested groups for non-subscribers who are associated with the specified geographic area and whose age is within the specified age range.

What is claimed:

1. A computer-implemented method comprising: identifying content objects and entities related to an interest of a user or associated with an entity related to the interest of that user and based on a distance from a geographic location, with each content object and entity having a set geographic location, inheriting their location from a parent entity, or being global in scope.
